(19) United States
(12) Patent Application Publication
(10) Pub. No.: US 2026/0208961 A1
(43) Pub. Date: Jul. 23, 2026

(54) WORKPIECE TRANSPORT MECHANISM

(71) Applicant: Honda Motor Co., Ltd., Tokyo (JP)

(72) Inventors: Hideki KANAI, Tokyo (JP); Kazuya YOSHIHARA, Tokyo (JP); Masahiro KOIKE, Tokyo (JP); Keita MASAKI, Tokyo (JP); Noritaka TAMURA, Tokyo (JP); Keita BABA, Tokyo (JP); Ryo KATSUMI, Tokyo (JP); Yoshikazu ISHIZAKA, Tokyo (JP); Kenji MATSUTANI, Tokyo (JP)

(73) Assignee: Honda Motor Co., Ltd., Tokyo (JP)

(21) Appl. No.: 19/383,715

(22) Filed: Nov. 9, 2025

(30) Foreign Application Priority Data
Jan. 17, 2025 (CN) 202520114149.6

(51) Int. Cl. B65G 17/12

(52) U.S. Cl. CPC B65G 17/12

(57) ABSTRACT

A workpiece transport mechanism is provided. The workpiece transport mechanism includes: a rotating shaft disposed below a workpiece transport path surface; and a workpiece movement restricting member supported by the rotating shaft and having a carry-in downstream side swinging portion and a carry-in upstream side swinging portion. In a free state, the carry-in downstream side swinging portion is located on a downstream side of the rotating shaft in a workpiece carry-in direction, and an inclined convex portion thereof protrudes from the workpiece transport path surface. The carry-in upstream side swinging portion is located on an upstream side of the rotating shaft in the workpiece carry-in direction and is located below the workpiece transport path surface.

### CROSS-REFERENCE TO RELATED APPLICATION

This application claims the priority benefit of China application serial no. 202520114149.6, filed on January 17, 2025. The entirety of the above-mentioned patent application is hereby incorporated by reference herein and made a part of this specification.

### BACKGROUND

### Technical Field

The disclosure relates to a transport mechanism, and more particularly to a workpiece transport mechanism.

### Description of Related Art

In the manufacturing and assembly process of vehicles, stamped and molded vehicle door panels are hung on rods of carts to facilitate transporting the door panels to subsequent work stations using the carts. Specifically, the operator aligns the speaker installation holes or other openings of the door panels with the free ends (upstream) of the rods of the carts, and pushes the door panels along the direction toward the fixed ends (downstream) of the rods, thereby sequentially hanging multiple door panels on the same rod of the cart. In some designs of cart rods, the rods are provided with movable stoppers. After a door panel is carried into a predetermined position on the rod along the direction from the upstream to the downstream, the stopper is converted to a state capable of blocking the next door panel on the upstream side of the door panel to avoid the next door panel from contacting or colliding with the door panel. However, when the operator wants to remove the door panels on the rod along the direction from the downstream to the upstream, the stopper interferes with the upstream movement of the door panels, resulting in operational inconvenience.

### SUMMARY

The disclosure is directed to a workpiece transport mechanism that allows workpieces to be conveniently removed after being carried in.

According to an embodiment of the disclosure, a workpiece transport mechanism is installed on a workpiece transport path component, and the workpiece is suitable for moving from an upstream of the workpiece transport path component and suitable for moving from a downstream of the workpiece transport path component. The workpiece transport mechanism includes: a rotating shaft disposed below a workpiece transport path surface of the workpiece transport path component; and a workpiece movement restricting member supported by the rotating shaft and having a carry-in downstream side swinging portion and a carry-in upstream side swinging portion. In a free state of the workpiece movement restricting member, the carry-in downstream side swinging portion is located on a downstream side of the rotating shaft in a workpiece carry-in direction and protrudes from the workpiece transport path surface. The carry-in upstream side swinging portion is located on an upstream side of the rotating shaft in the workpiece carry-in direction and is located below the workpiece transport path surface. The carry-in downstream side swinging portion has an inclined convex portion, and the inclined convex portion protrudes from the workpiece transport path surface. When the workpiece moves from the upstream to the downstream and is carried in, the workpiece presses the inclined convex portion to cause the workpiece movement restricting member to swing, the carry-in upstream side swinging portion thereby protruding from the workpiece transport path surface to form a carry-in workpiece restricting wall. When the workpiece moves from the downstream to the upstream and is removed, the workpiece presses the inclined convex portion of the workpiece movement restricting member in the free state to cause the workpiece movement restricting member to swing along a direction such that the carry-in downstream side swinging portion does not protrude from the workpiece transport path surface.

According to an embodiment of the disclosure, a workpiece transport mechanism is installed on a workpiece transport path component, and the workpiece is suitable for moving from an upstream of the workpiece transport path component and suitable for moving from a downstream of the workpiece transport path component. The workpiece transport mechanism includes: a workpiece stopper disposed on a downstream side of the workpiece transport path component in a workpiece carry-in direction; a plurality of rotating shafts disposed below a workpiece transport path surface of the workpiece transport path component; and a plurality of workpiece movement restricting members respectively supported by the plurality of rotating shafts. Each of the plurality of workpiece movement restricting members has a carry-in downstream side swinging portion and a carry-in upstream side swinging portion. In a free state of the workpiece movement restricting member, the carry-in downstream side swinging portion is located on a downstream side of the rotating shaft in the workpiece carry-in direction and protrudes from the workpiece transport path surface. The carry-in upstream side swinging portion is located on an upstream side of the rotating shaft in the workpiece carry-in direction and is located below the workpiece transport path surface. The carry-in downstream side swinging portion has an inclined convex portion, and the inclined convex portion protrudes from the workpiece transport path surface. When the workpiece moves from the upstream to the downstream and is carried in, the workpiece presses the inclined convex portion to cause the workpiece movement restricting member to swing, the carry-in upstream side swinging portion thereby protruding from the workpiece transport path surface to form a carry-in workpiece restricting wall. When the most upstream workpiece stopped by the carry-in workpiece restricting wall moves toward the upstream and is removed, the workpiece presses the inclined convex portion of the workpiece movement restricting member in the free state to cause the workpiece movement restricting member to swing along a direction such that the carry-in downstream side swinging portion does not protrude from the workpiece transport path surface.

In an embodiment according to the disclosure, a plurality of the workpiece transport path components are arranged in parallel.

In an embodiment according to the disclosure, in the plurality of workpiece transport path components arranged in parallel, when observed from a side, the plurality of rotating shafts located below the workpiece transport path surface are disposed at equal intervals. When observed from above, the plurality of rotating shafts located below the workpiece transport path surface are disposed in a staggered method.

According to an embodiment of the disclosure, in a workpiece transport mechanism installed on a workpiece transport path component, a workpiece transport method moves workpieces from an upstream to a downstream of the workpiece transport path component and moves workpieces from the downstream to the upstream of the workpiece transport path component, the workpiece transport mechanism includes: a workpiece stopper, disposed on a downstream side in a workpiece carry-in direction of the workpiece transport path component; and a plurality of workpiece movement restricting members, each of the plurality of workpiece movement restricting members has a carry-in downstream side swinging portion and a carry-in upstream side swinging portion, in a free state of the workpiece movement restricting member, the carry-in downstream side swinging portion is located on a downstream side in the workpiece carry-in direction and protrudes from the workpiece transport path surface, the carry-in upstream side swinging portion is located below the workpiece transport path surface, the carry-in downstream side swinging portion has an inclined convex portion, the inclined convex portion protrudes from the workpiece transport path surface, when the workpiece moves from the upstream toward the downstream and is carried in, the workpiece presses the inclined convex portion to make the workpiece movement restricting member swing, thereby the carry-in upstream side swinging portion protrudes from the workpiece transport path surface to form a carry-in workpiece restricting wall, the workpiece transport method includes the following steps: the most upstream workpiece stopped by the carry-in workpiece restricting wall presses the inclined convex portion of the workpiece movement restricting member in the free state, the workpiece movement restricting member swings along a direction that makes the carry-in downstream side swinging portion not protrude from the workpiece transport path surface.

Based on the above, in the workpiece transport mechanism of the disclosure, when a user carries in a workpiece along a direction from an upstream to a downstream of the workpiece transport path component, the inclined convex portion of the carry-in downstream side swinging portion in a free state is pressed downward by the workpiece, thereby driving the carry-in upstream side swinging portion of the workpiece movement restricting member to protrude upward to form a carry-in workpiece restricting wall, the carry-in workpiece restricting wall may stop a next workpiece, preventing the next workpiece from contacting or colliding with the aforementioned workpiece. Subsequently, when the user carries out the workpiece on the workpiece transport path component along a direction from the downstream to the upstream of the workpiece transport path component, the inclined convex portion of the carry-in downstream side swinging portion in the free state is again pressed downward by the workpiece without hindering the carry-out of the workpiece. Thus, the workpiece transport mechanism of the disclosure may enable the workpiece to be conveniently carried out after being carried in.

### BRIEF DESCRIPTION OF THE DRAWINGS

FIG. 1 is a top view of a cart according to an embodiment of the disclosure.

FIG. 2 is a side view of a workpiece transport path component of FIG. 1 with a workpiece suspended.

FIG. 3A to FIG. 3C show an operation process of the workpiece transport mechanism of FIG. 2 when a workpiece is carried in.

FIG. 4A to FIG. 4C show an operation process of the workpiece transport mechanism of FIG. 2 when a workpiece is carried out.

FIG. 5 is a top view of the workpiece transport path component of FIG. 2.

FIG. 6 is a side view of a workpiece transport path component with a workpiece suspended according to another embodiment of the disclosure.

FIG. 7 is a flowchart of a workpiece transport method according to an embodiment of the disclosure.

### DESCRIPTION OF THE EMBODIMENTS

Reference will now be made in detail to exemplary embodiments of the disclosure, and examples of the exemplary embodiments are illustrated in the accompanying drawings. Wherever possible, the same reference numerals will be used throughout the drawings and the description to refer to the same or like parts.

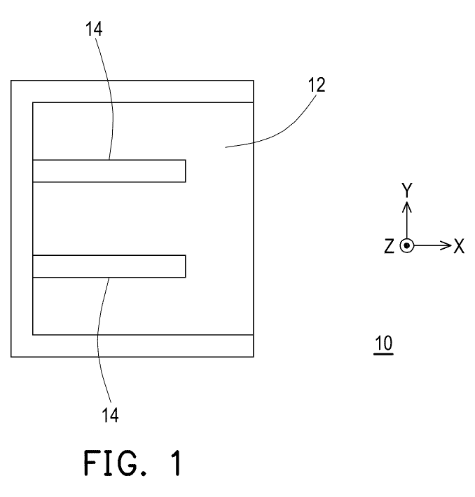

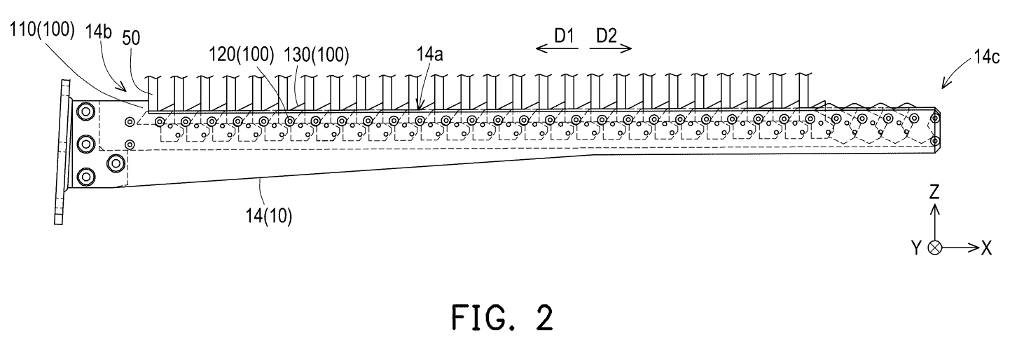

FIG. 1 is a top view of a cart according to an embodiment of the disclosure, showing axials X, Y, Z. FIG. 2 is a side view of the workpiece transport path component of FIG. 1 with a workpiece suspended. Referring to FIG. 1 and FIG. 2, a cart 10 of this embodiment is used, for example, to transport a workpiece 50 in a vehicle manufacturing plant. The cart 10 includes a cart body 12 and a plurality of workpiece transport path components (FIG. 1 schematically shows two workpiece transport path components 14), the cart body 12 may be pushed and moved by a user. The workpiece transport path component 14 is, for example, a rod-like structure, which is disposed on the cart body 12 and is used for the workpiece 50 to be suspended.

The workpiece 50 may move from an upstream 14c of the workpiece transport path component 14 toward a downstream 14b of the workpiece transport path component 14 to carry in the workpiece 50. The workpiece 50 may move from the downstream 14b of the workpiece transport path component 14 toward the upstream 14c of the workpiece transport path component 14 to carry out the workpiece 50. The workpiece 50 in FIG. 2 is only schematically shown partially. The workpiece 50 is, for example, a stamped vehicle door panel and is suspended on the workpiece transport path component 14, for example, through speaker mounting holes or other openings that it has, but the disclosure is not limited thereto.

Referring to FIG. 2, in this embodiment, a workpiece transport mechanism 100 is installed on the workpiece transport path component 14 and includes a workpiece stopper 110, a plurality of rotating shafts 120, and a plurality of workpiece movement restricting members 130. The workpiece stopper 110 is disposed on the downstream side of the workpiece transport path component 14 in a workpiece carry-in direction D1. The plurality of rotating shafts 120 are disposed below a workpiece transport path surface 14a of the workpiece transport path component 14. The plurality of workpiece movement restricting members 130 are respectively pivotally connected to the plurality of rotating shafts 120 and are respectively supported by the plurality of rotating shafts 120.

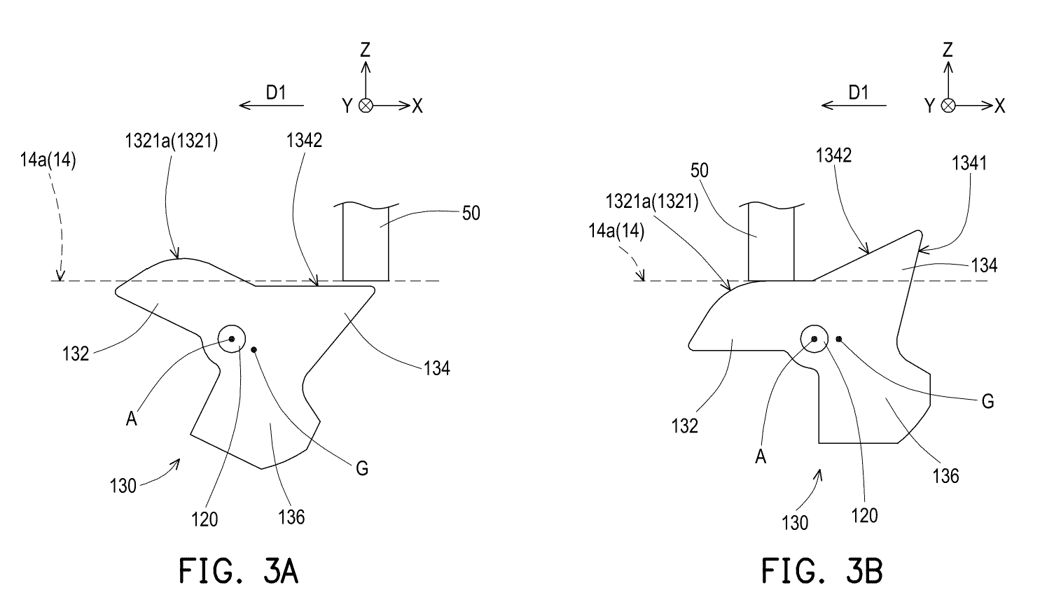

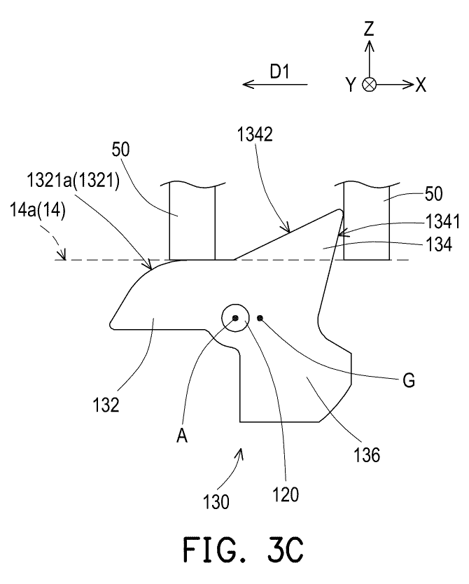

FIG. 3A to FIG. 3C show the operation process of the workpiece transport mechanism of FIG. 2 when the workpiece is carried in. Referring to FIG. 3A, the workpiece movement restricting member 130 is pivotally connected to the rotating shaft 120 along a rotation axis A parallel to the axial Y. The workpiece movement restricting member 130 has a carry-in downstream side swinging portion 132, a carry-in upstream side swinging portion 134, and a counterweight portion 136. Through the disposition of the counterweight portion 136, a center of gravity G of the workpiece movement restricting member 130 and the rotation axis A have the relative position shown in FIG. 3A. In the free state of the workpiece movement restricting member 130 (i.e., the state where the workpiece movement restricting member 130 is not pressed by the workpiece 50 or other objects) shown in FIG. 3A, the carry-in downstream side swinging portion 132 is located on the downstream side of the rotating shaft 120 in the workpiece carry-in direction D1 and protrudes from the workpiece transport path surface 14a, and the carry-in upstream side swinging portion 134 is located on the upstream side of the rotating shaft 120 in the workpiece carry-in direction D1 and is located below the workpiece transport path surface 14a. The carry-in downstream side swinging portion 132 has an inclined convex portion 1321, and the inclined convex portion 1321 protrudes from the workpiece transport path surface 14a.

When the workpiece 50 moves from the upstream 14c (indicated in FIG. 2) along the workpiece carry-in direction D1 toward the downstream 14b (indicated in FIG. 2) and is carried in, the workpiece 50 presses the inclined convex portion 1321 as shown in FIG. 3A to FIG. 3B to cause the workpiece movement restricting member 130 to swing, so that the carry-in upstream side swinging portion 134 protrudes from the workpiece transport path surface 14a as shown in FIG. 3B to form a carry-in workpiece restricting wall 1341. Thus, when the next workpiece 50 moves from the upstream 14c (indicated in FIG. 2) along the workpiece carry-in direction D1 toward the downstream 14b (indicated in FIG. 2) and is carried in, this workpiece 50 will be stopped by the carry-in workpiece restricting wall 1341 as shown in FIG. 3C. According to this method, a plurality of workpieces 50 may be carried in sequentially, and the plurality of workpieces 50 may be suspended on the workpiece transport path component 14 as shown in FIG. 2.

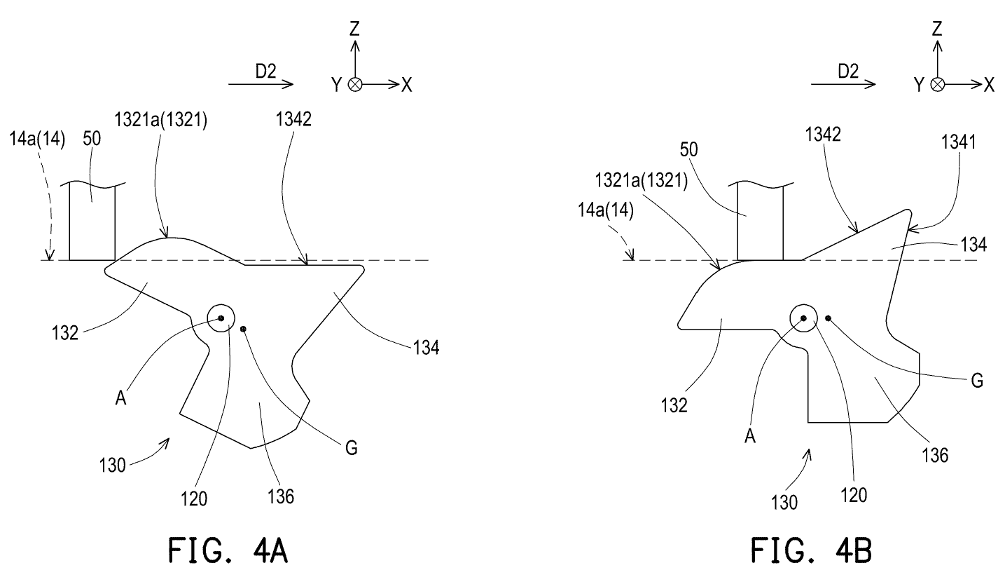

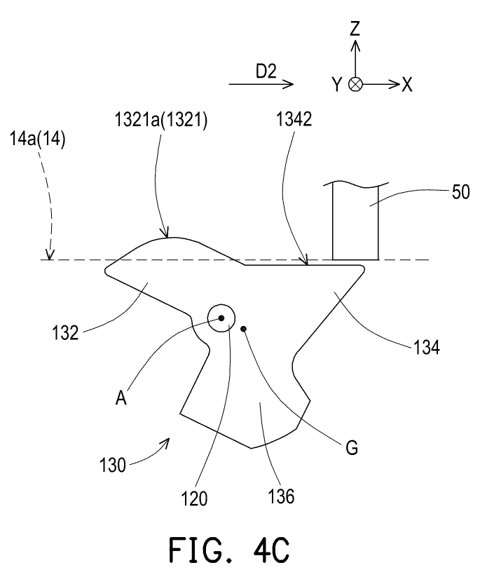

FIG. 4A to FIG. 4C show the operation process of the workpiece transport mechanism of FIG. 2 during workpiece carry-out. Among the plurality of workpieces 50 suspended on the workpiece transport path component 14 shown in FIG. 2, the workpiece 50 closest to the upstream 14c may start to be carried out, so that the plurality of workpieces 50 are carried out sequentially. When the most upstream workpiece 50 stopped by the carry-in workpiece restricting wall 1341 moves along a workpiece carry-out direction D2 toward the upstream 14c and is carried out, this workpiece 50 presses the inclined convex portion 1321 of the workpiece movement restricting member 130 in the free state and located on the upstream side of the workpiece 50 as shown in FIG. 4A to FIG. 4C, causing this workpiece movement restricting member 130 to swing in a direction such that the carry-in downstream side swinging portion 132 does not protrude from the workpiece transport path surface 14a.

Next, in the process of the workpiece 50 continuing to move along the workpiece carry-out direction D2 toward the upstream 14c, the workpiece 50 gradually disengages from the carry-in downstream side swinging portion 132 and pushes the carry-in upstream side swinging portion 134, thereby causing the workpiece movement restricting member 130 to return to the free state through the weight of the counterweight portion 136 as shown in FIG. 4C. Thus, after all workpieces 50 are carried out, a plurality of workpieces 50 may be carried in sequentially again by the method shown in FIG. 3A to FIG. 3C.

As described above, in the workpiece transport mechanism 100 of this embodiment, when the user carries the workpiece 50 in along the workpiece carry-in direction D1, the inclined convex portion 1321 of the carry-in downstream side swinging portion 132 in the free state is pressed downward by the workpiece 50, thereby driving the carry-in upstream side swinging portion 134 of the workpiece movement restricting member 130 to protrude upward to form the carry-in workpiece restricting wall 1341. The carry-in workpiece restricting wall 1341 may stop the next workpiece 50, preventing the next workpiece 50 from contacting or colliding with the aforementioned workpiece 50. Next, when the user carries the workpiece 50 on the workpiece transport path component 14 out along the workpiece carry-out direction D2, the inclined convex portion 1321 of the carry-in downstream side swinging portion 132 in the free state is pressed downward by the workpiece 50 again without hindering the carry-out of the workpiece 50. Thus, the workpiece transport mechanism 100 of this embodiment may enable the workpiece 50 to be conveniently carried out after being carried in.

In this embodiment, the inclined convex portion 1321 of the carry-in downstream side swinging portion 132 has a guide curved surface 1321a. When the workpiece 50 moves along the workpiece carry-in direction D1 and contacts the inclined convex portion 1321 as shown in FIG. 3A to FIG. 3B, the workpiece 50 smoothly presses the inclined convex portion 1321 downward through the guidance of the guide curved surface 1321a. Similarly, when the workpiece 50 moves along the workpiece carry-out direction D2 and contacts the inclined convex portion 1321 as shown in FIG. 4A to FIG. 4B, the workpiece 50 smoothly presses the inclined convex portion 1321 downward through the guidance of the guide curved surface 1321a. Furthermore, in this embodiment, the upper side of the carry-in upstream side swinging portion 134 is, for example, formed as a plane 1342, and the plane 1342 does not protrude from the workpiece transport path surface 14a in the free state of the workpiece movement restricting member 130.

As shown in FIG. 1, in this embodiment, a plurality of workpiece transport path components 14 (two are shown) are arranged in parallel along the horizontal direction (the axial Y). Accordingly, each workpiece 50 may be penetrated by the plurality of workpiece transport path components 14, thereby enabling stable transport of the workpiece 50. Furthermore, the distance between the plurality of workpiece transport path components 14 may be set according to the width of the workpiece to be transported, such that the workpiece 50 may be stably transported even when the workpiece width is large.

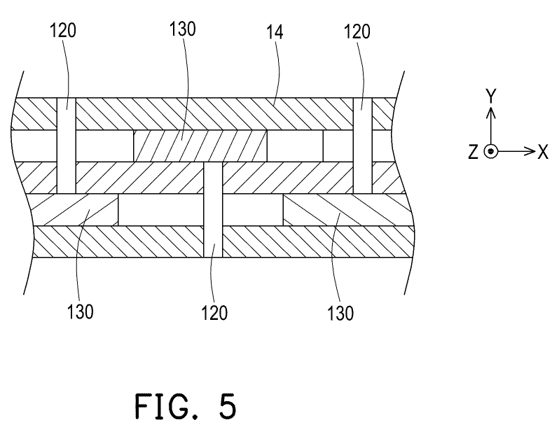

FIG. 5 is a top view of the workpiece transport path component of FIG. 2. In the plurality of workpiece transport path components 14 arranged in parallel, when observed from the side as shown in FIG. 2, the plurality of rotating shafts 120 located below the workpiece transport path surface 14a are disposed at equal intervals, and when observed from above as shown in FIG. 5, the plurality of rotating shafts 120 located below the workpiece transport path surface 14a are disposed in a staggered manner. Accordingly, the workpiece transport mechanism 100 may be disposed in a more compact manner in the axial X direction, thereby enabling the workpiece transport path component 14 to accommodate a greater number of relatively thin workpieces 50.

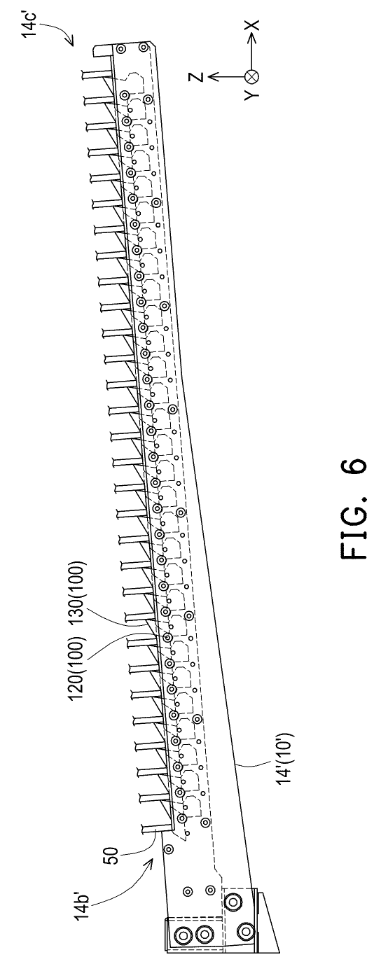

FIG. 6 is a side view of a workpiece transport path component suspending a workpiece according to another embodiment of the disclosure. The main difference between the embodiment shown in FIG. 6 and the embodiment shown in FIG. 2 is that a workpiece transport path component 14’ in FIG. 6 is inclined downward along the direction from an upstream 14c’ toward a downstream 14b’. Accordingly, the workpiece 50 may slide from the upstream 14c’ along the workpiece transport path component 14’ toward the downstream 14b’ through gravity, allowing the user to carry in the workpiece 50 in an effortless manner. Moreover, when the cart 10’ moves, the workpiece 50 suspended on the inclined workpiece transport path component 14’ is not easily ejected from the upstream 14c’, and the workpiece 50 may be stably transported. The remaining configurations and operation methods of the embodiment shown in FIG. 6 are the same or similar to those of the embodiment shown in FIG. 2, and will not be described in detail herein.

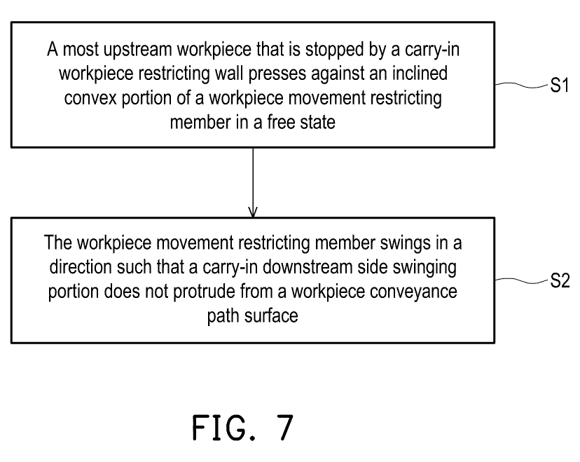

The following describes a workpiece transport method according to an embodiment of the disclosure with reference to the embodiments shown in FIG. 1 to FIG. 5. FIG. 7 is a flowchart of a workpiece transport method according to an embodiment of the disclosure. The workpiece transport method moves the workpiece 50 from the upstream 14c toward the downstream 14b of the workpiece transport path component 14, and moves the workpiece 50 from the downstream 14b toward the upstream 14c of the workpiece transport path component 14 in the workpiece transport mechanism 100 installed on the workpiece transport path component 14. Referring to FIG. 7, the workpiece transport method includes the following steps. The most upstream workpiece 50 stopped by the carry-in workpiece restricting wall 1341 presses the inclined convex portion 1321 of the workpiece movement restricting member 130 in a free state (step S1), and the workpiece movement restricting member 130 swings along a direction such that the carry-in downstream side swinging portion 132 does not protrude from the workpiece transport path surface 14a (step S2).

In summary, in the workpiece transport mechanism of the disclosure, when the user carries in the workpiece along the direction from the upstream toward the downstream of the workpiece transport path component, the inclined convex portion of the carry-in downstream side swinging portion in a free state is pressed downward by the workpiece, thereby driving the carry-in upstream side swinging portion of the workpiece movement restricting member to protrude upward to form the carry-in workpiece restricting wall. The carry-in workpiece restricting wall may stop the next workpiece, preventing the next workpiece from contacting or colliding with the aforementioned workpiece. Subsequently, when the user carries out the workpiece on the workpiece transport path component along the direction from the downstream toward the upstream of the workpiece transport path component, the inclined convex portion of the carry-in downstream side swinging portion in a free state is again pressed downward by the workpiece without hindering the carry-out of the workpiece. Therefore, the workpiece transport mechanism of the disclosure may enable the workpiece to be conveniently carried out after being carried in.

Finally, it should be noted that the above embodiments are only used to illustrate the technical solutions of the disclosure, and are not intended to limit them; although the disclosure has been described in detail with reference to the aforementioned embodiments, those skilled in the art should understand that they may still modify the technical solutions described in the aforementioned embodiments, or make equivalent substitutions for some or all of the technical features thereof; and these modifications or substitutions do not cause the essence of the corresponding technical solutions to depart from the scope of the technical solutions of the embodiments of the disclosure.

What is claimed is:

1. A workpiece transport mechanism installed on a workpiece transport path component, wherein a workpiece is suitable for moving from an upstream of the workpiece transport path component and suitable for moving from a downstream of the workpiece transport path component, and the workpiece transport mechanism comprises:
a rotating shaft disposed below a workpiece transport path surface of the workpiece transport path component; and
a workpiece movement restricting member supported by the rotating shaft and having a carry-in downstream side swinging portion and a carry-in upstream side swinging portion,
wherein in a free state of the workpiece movement restricting member, the carry-in downstream side swinging portion is located on a downstream side of the rotating shaft in a workpiece carry-in direction and protrudes from the workpiece transport path surface, the carry-in upstream side swinging portion is located on an upstream side of the rotating shaft in the workpiece carry-in direction and is located below the workpiece transport path surface,
the carry-in downstream side swinging portion has an inclined convex portion, and the inclined convex portion protrudes from the workpiece transport path surface, wherein
when the workpiece moves from the upstream to the downstream and is carried in, the workpiece presses the inclined convex portion to cause the workpiece movement restricting member to swing, thereby causing the carry-in upstream side swinging portion to protrude from the workpiece transport path surface to form a carry-in workpiece restricting wall,
when the workpiece moves from the downstream to the upstream and is carried out, the workpiece presses the inclined convex portion of the workpiece movement restricting member in the free state, to cause the workpiece movement restricting member to swing along a direction that causes the carry-in downstream side swinging portion not to protrude from the workpiece transport path surface.

2. A workpiece transport mechanism installed on a workpiece transport path component, wherein a workpiece is suitable for moving from an upstream of the workpiece transport path component and suitable for moving from a downstream of the workpiece transport path component, wherein the workpiece transport mechanism comprises:
a workpiece stopper disposed on a downstream side of the workpiece transport path component in a workpiece carry-in direction;
a plurality of rotating shafts disposed below a workpiece transport path surface of the workpiece transport path component; and
a plurality of workpiece movement restricting members respectively supported by the plurality of rotating shafts, and each of the plurality of workpiece movement restricting members has a carry-in downstream side swinging portion and a carry-in upstream side swinging portion, wherein
in a free state of the workpiece movement restricting member, the carry-in downstream side swinging portion is located on a downstream side of the rotating shaft in the workpiece carry-in direction and protrudes from the workpiece transport path surface, the carry-in upstream side swinging portion is located on an upstream side of the rotating shaft in the workpiece carry-in direction and is located below the workpiece transport path surface,
the carry-in downstream side swinging portion has an inclined convex portion, and the inclined convex portion protrudes from the workpiece transport path surface, wherein
when the workpiece is carried in by moving from the upstream toward the downstream, the workpiece presses the inclined convex portion to make the workpiece movement restricting member swing, so that the carry-in upstream side swinging portion protrudes from the workpiece transport path surface to form a carry-in workpiece restricting wall, and
when the most upstream workpiece stopped by the carry-in workpiece restricting wall is carried out by moving toward the upstream, the workpiece presses the inclined convex portion of the workpiece movement restricting member in the free state to make the workpiece movement restricting member swing along a direction that makes the carry-in downstream side swinging portion not protrude from the workpiece transport path surface.

3. The workpiece transport mechanism according to claim 2, wherein
a plurality of the workpiece transport path components are arranged in parallel.

4. The workpiece transport mechanism according to claim 3, wherein
in the plurality of workpiece transport path components arranged in parallel, when observed from a side, the plurality of rotating shafts located below the workpiece transport path surface are disposed at an equal interval, and when observed from above, the plurality of rotating shafts located below the workpiece transport path surface are disposed in a staggered manner.
